(19) United States
(12) Patent Application Publication
(10) Pub. No.: US 2009/0290325 A1
(43) Pub. Date: Nov. 26, 2009

(54) FLUORESCENT SUBSTANCE AND PROCESS FOR PRODUCING THE SAME

(75) Inventor: Hideo Tamamura, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/097,988

(22) PCT Filed: Jan. 26, 2007
(86) PCT No.: PCT/JP2007/051750

§ 371 Date: Jun. 18, 2008

Related U.S. Application Data
(60) Provisional application No. 60/764,371, filed on Feb. 2, 2006.

(30) Foreign Application Priority Data
Jan. 27, 2006 (JP) 2006-091323

(51) Int. Cl. F21V 9/16; C09K 11/81; C09K 11/70

(52) U.S. Cl. 362/84; 252/301.4 R; 252/301.4 P

(57) ABSTRACT

A fluorescent substance which excels in light-emitting characteristics and versatility, and which can emit light stably, and a lamp using the same are provided at a low cost. Such a fluorescent substance consists of a fluorescent substance which mainly consists of a garnet structure and an element of group V added thereto. Preferably, the fluorescent substance includes a fluorescent substance having a garnet structure in which yttrium.aluminum.garnet (Y₃Al₅O₁₂) is contained as a base component, and further an activator.

Priority is claimed on Japanese Patent Application No. 2006-019323, filed Jan. 27, 2006, and Provisional Patent Application No. 60/764,371, filed Feb. 2, 2006, the content of which is incorporated herein by reference.

### TECHNICAL FIELD

The present invention relates to a fluorescent substance which is capable of exciting visible lights excitation, in particular a fluorescent substance which converts a primary light emission wavelength from a light source so as to emit it as a secondary light emission wavelength, a process for producing the same, and a lamp.

### BACKGROUND ART

In recent years, a lamp in which a light-emitting diode (LED) is combined with a fluorescent light, having a small size, high intensity, and a long life has been proposed. Such a lamp uses an LED, and hence it can save electric power, and is used in various broad uses such as a display, a backlight source, a traffic signal and various indicators etc.

The lamp in which an LED is combined with a fluorescent light in the above can emit light having an arbitrary color tone by converting the light emission wavelength of an LED using one or more kinds of fluorescent light into a secondary light-emitting wavelength, even if a primary light-emitting wavelength of the LED as a light source is only of one kind.

Thereby a lamp which is capable of emitting light stably is available at low cost, and such a lamp has been widely used as described in the above.

As a fluorescent substance for use in a lamp which uses an LED as a light source, a fluorescent substance having a garnet structure (YAG:Ce═Y₃Al₅O₁₂:Ce) in which the base component is yttrium.aluminum.garnet (YAG=Y₃Al₅O₁₂), and in which cerium (Ce) is contained as an activator, has been widely known.

Since such a YAG:Ce fluorescent substance having a garnet structure has excellent temperature characteristics, a broad excitation wavelength, and high converting efficiency of light wavelength, and in particular excites efficiently in a blue domain near 460 nm, it has been widely used in a lamp which uses an LED in addition to being has been used for a white lamp which emits yellow light by blue LED excitation.

A lamp which makes emitted light an arbitrary color tone by converting a primary light-emitting wavelength emitted from an LED using a YAG:Ce fluorescent substance into a secondary light-emitting wavelength has been disclosed in Patent document 1.

[Patent document 1] Japanese Patent Publication No. 3,065,258

### DISCLOSURE OF THE INVENTION

In the lamp which uses a YAG:Ce fluorescent substance disclosed in Patent document 1, the wavelength of light emitted from an LED is efficiently converted into an arbitrary color tone by the above constitution.

However, the lamp which uses the fluorescent substance disclosed in Patent document 1 fails to possess the light-emitting intensity of the secondary one sufficiently, and it is necessary to substitute a part of the component composition of a YAG:Ce fluorescent substance in order to convert the light-emitting wavelength (excitation wavelength) into an arbitrary band.

For this reason, development of a fluorescent substance which is capable of increasing light-emitting intensity and converting light-emitting wavelength easily has been strongly desired.

The present invention was made in view of the above circumstances, and it is an object of the present invention to provide a fluorescent substance which excels in light-emitting properties, general-purpose properties, and stable light-emitting properties, and which is available at low cost, a process for producing the same, and a lamp.

The present invention was made in order to solve the above objects, including the following invention.

That is, (1) a fluorescent substance including a fluorescent substance which mainly consists of a garnet structure, and an element of group V added thereto.

(2) The fluorescent substance as set forth in (1) in which the fluorescent substance includes a fluorescent substance having a garnet structure in which yttrium.aluminum.garnet (Y₃Al₅O₁₂) is contained as a base component, and an activator is further contained.

(3) The fluorescent substance as set forth in (1) or (2), in which the content of the element of group V is not more than 50 mol %.

(4) The fluorescent substance as set forth in (1) or (2), in which the content of the element of group V is not more than 25 mol %.

(5) The fluorescent substance as set forth in any one of (1) to (4), in which the element of group V is P, and is added in the state of a phosphorus compound.

(6) A process for producing a fluorescent substance including mixing Y compound, Al compound, Ce compound, and a compound of an element of group V and calcining the resultant mixture to form a fluorescent substance which mainly consists of garnet structure.

(7) The process for producing a fluorescent substance as set forth in (6), further including blending Y oxide, Al oxide, and Ce oxide so as to produce a predetermined composition ratio, and further adding a phosphorus compound, and then calcining the resultant mixture.

(8) The process for producing a fluorescent substance as set forth in (7), in which the Y oxide is Y₂O₃, the Al oxide is Al₂O₃, the Ce oxide is CeO₂, and the phosphorus compound is H₃PO₄.

(9) The process for producing a fluorescent substance as set forth in any one of (6) to (8), in which the calcining is performed in an inert gas.

(10) A fluorescent substance obtained by the process as set forth in any one of (6) to (9).

(11) A lamp including an LED as a light source, and a fluorescent substance as set forth in any one of (1) to (5) and (10) to absorb light emitted from the LED with the fluorescent substance and perform wavelength conversion.

(12) A lamp including an LED as a light source, and a fluorescent substance as set forth in any one of (1) to (5) and (10) to absorb light emitted from the LED with the fluorescent substance and emit white light.

The fluorescent substance in accordance with the present invention can change the light-emitting intensity and the light-emitting wavelength by the constitutions (1) to (5) shown in the above.

Moreover, since each of the light-emitting intensity and the light-emitting wavelength varies based on the kind and the content of an element of group V, a fluorescent substance having arbitrary properties can be obtained by changing the element to be added and the adding amount corresponding to the fluorescent substance properties which are required.

Moreover, the fluorescent substance described in (10) in the above having arbitrary properties can be obtained, in accordance with the process for producing a fluorescent substance having the constitutions (6) to (9) in the above, by changing the element to be added and adding amount thereof corresponding to the fluorescent substance characteristics which are required.

Moreover, the lamp which uses the fluorescent substance in accordance with the present invention can convert the light-emitting wavelength of an LED as a primary light source into a secondary light-emitting wavelength, by the constitutions (11) and (12) in the above, thereby providing a wavelength-converting type lamp having a large light-emitting intensity which can emit light with an arbitrary color tone.

In accordance with the fluorescent substance of the present invention and the process for producing the same, because of the constitutions and effects in the above, it is possible to make a secondary light-emitting wavelength of a fluorescent substance a wavelength of an arbitrary color tone and increase the light-emitting intensity.

Thereby it is possible to obtain light having high intensity and excellent light-emitting properties with an arbitrary color tone, by using one or more kinds of fluorescent substances, even if the primary light-emitting wavelength from an LED is the same wavelength.

Therefore, a lamp having high brightness, long life, small size, and excellent general-purpose properties can be provided at a low cost.

Since the lamp which uses the fluorescent substance of the present invention excels in general-purpose properties, it can be used for various uses such as a display, an LCD backlight, a white LED, an LED for use in illumination; in particular, high efficiency can be provided in the case of using the lamp as a white LED lamp.

### BRIEF DESCRIPTION OF THE DRAWINGS

FIG. 1 is a figure for explaining an example of the fluorescent substance of the present invention, and is a graph which shows the correlation between the added amount of H₃PO₄ and the light-emitting intensity in Example 1.

FIG. 2 is a figure for explaining an example of the fluorescent substance of the present invention, and is a graph which shows the correlation between the added amount of H₃PO₄ and the light-emitting wavelength in Example 1.

FIG. 3 is a figure for explaining an example of the fluorescent substance of the present invention, and is a graph which shows the correlation between the Ce₂O₃ concentration and the light-emitting intensity in the case of fixing the H₃PO₄ concentration to be 3 mole % in Example 2.

FIG. 4 is a figure for explaining an example of the fluorescent substance of the present invention, and is a graph which shows the correlation between the Ce₂O₃ concentration and the light-emitting wavelength in the case of fixing the H₃PO₄ concentration to be 3 mole % in Example 2.

FIG. 5 is a figure for explaining an example of the fluorescent substance of the present invention, and is a graph which shows the correlation between the concentration of P when synthesizing the fluorescent substance and the concentration of P after the fluorescent substance was synthesized in Example 3.

### BEST MODE FOR CARRYING OUT THE INVENTION

An explanation will be given below about embodiments of a fluorescent substance in accordance with the present invention and a lamp using the same.

### Fluorescent Substance

The fluorescent substance of the present invention is constituted by adding an element of group V to a fluorescent substance which approximately consists of a garnet structure mainly.

The fluorescent substance of the present invention is, for example, formed lamellarly onto a light-emitting device as a light source, such as an LED, and is capable of emitting light with an arbitrary color tone by excitation of the light source and of increasing the emitting intensity.

A detailed explanation will be given below about the composition of a fluorescent substance of the present invention.

### “Activator”

In the fluorescent substance in a preferred embodiment of the present invention, the fluorescent substance which consists mainly of the garnet structure contains yttrium.aluminum.garnet (YAG=Y₃Al₅O₁₂) as a base component, and a fluorescent substance having the garnet structure, for example, containing cerium (Ce) etc., as an activator. In the fluorescent substance of this embodiment, the luminous efficiency is increased by containing Ce as an activator. It should be noted that the activator to be contained in the fluorescent substance is not limited to Ce, and any other element can be used appropriately.

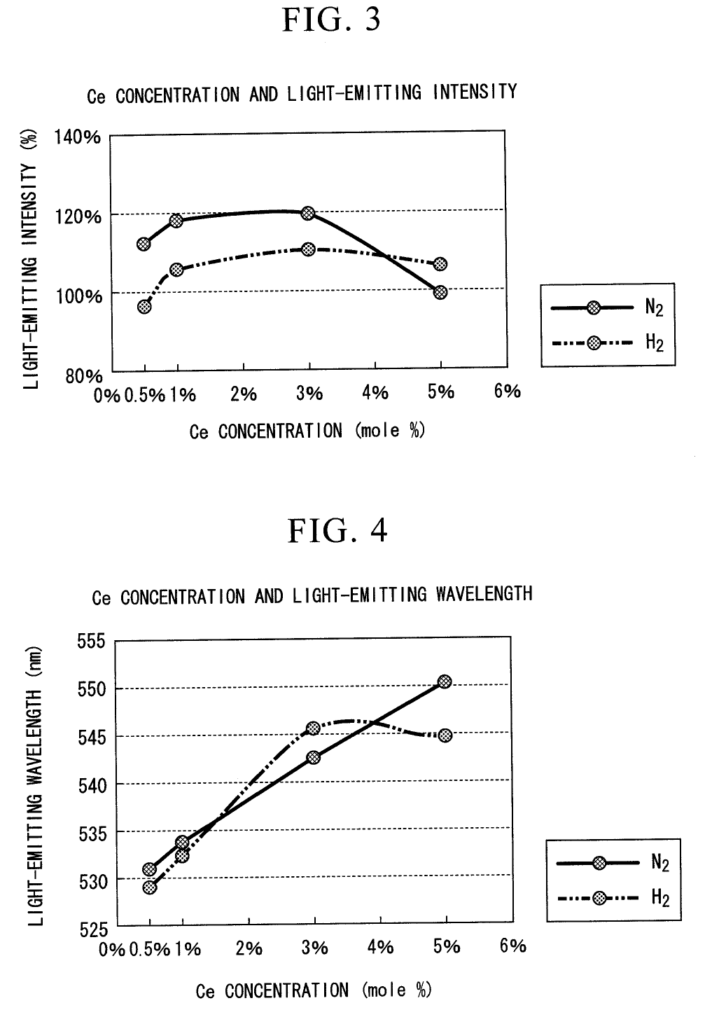

As shown in the graph in FIG. 4, as the content of Ce increases, the light-emitting wavelength of the fluorescent substance becomes higher. For this reason, it is preferable to adjust the added amount of Ce within the range in which the light-emitting intensity shown in the graph in FIG. 3 will not decrease to obtain a desirable light-emitting wavelength.

A desirable light-emitting wavelength can be obtained, while increasing the light-emitting intensity, by forming the fluorescent substance of the present invention lamellarly onto a light-emitting device.

### “Element of Group V”

In the fluorescent substance of the present invention, an element of group V is added to a fluorescent substance which mainly consists of the garnet structure such as YAG:Ce, etc.

The element of group V which is added to the fluorescent substance of the present invention is at least one selected from the group consisting of N, P, As, Sb and Bi, and the light-emitting intensity significantly increases by adding the above element of group V to a fluorescent substance which mainly consists of the garnet structure.

In addition, each of the light-emitting intensity and the light-emitting wavelength varies depending on the kind and the amount of the element in group V to be added to the fluorescent substance.

A fluorescent substance having an arbitrary characteristic can be obtained by appropriately setting the element of group V to be added and the amount of the element of group V to be added, corresponding to the desirable fluorescent substance characteristics.

The fluorescent substance of the present invention preferably has the content of the element of group V of not more than 50 mole %, more preferably of not more than 25 mole %.

The light-emitting intensity and the light-emitting characteristics can be increased more efficiently, by specifying the content of the element of group V to be added to the fluorescent substance to be the above range.

If the content of the element of group V is over 50 mole %, then the above effect hardly becomes obtainable.

Moreover, in the fluorescent substance of the present invention, the above element of group V is preferably P (phosphorus), and the P to be contained in the fluorescent substance is preferably added in a state of a phosphorus compound.

As the phosphorus compound, for example phosphates, such as H₃PO₄, are exemplary, and any one may be selectively used.

The light-emitting intensity will increase further, by specifying the element of group V to be contained in the fluorescent substance to be P.

### “Process for Producing”

The process for producing a fluorescent substance of the present invention is approximately constituted, as a method for obtaining a fluorescent substance which mainly consists of the garnet structure, by mixing a Y compound, an Al compound, a Ce compound and a compound of an element of group V and calcining the mixture.

Moreover, the process for producing a fluorescent substance of the present invention may be a process including compounding a Y oxide, an Al oxide and a Ce oxide such that each of them will be a predetermined composition ratio, and further adding a phosphorus compound, and then calcining the resultant mixture.

In the case of producing the fluorescent substances of the present invention, for example, each of Y₂O₃, Al₂O₃, CeO₂ is used as raw materials to be compound so as to form Y₃Al₅O₁₂:Ce, and the element of group V, such as H₃PO₄, etc. as a phosphorus compound is added in an amount such that a desirable light-emitting intensity and wavelength can be obtained. And thereafter, the resultant mixture is calcined at a predetermined temperature and time, thereby providing the fluorescent substance of the present invention.

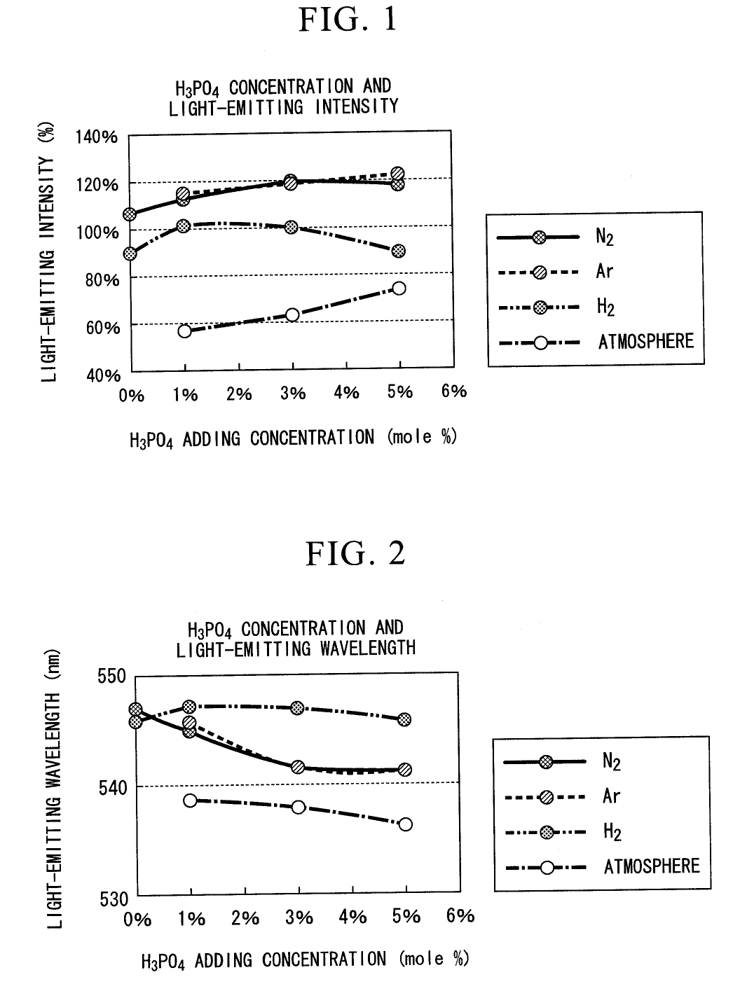

When producing the fluorescent substances of the present invention, in the case of using P as the element of group V to be added, and of adding H₃PO₄, as shown in the graph in FIG. 1, the light-emitting intensity will increase as the added concentration of the H₃PO₄ becomes higher. Moreover, as shown in FIG. 2, there are no significant change in the light-emitting wavelength of the fluorescent substance, even if the added concentration of the H₃PO₄ changes.

For this reason, as for the added concentration of the H₃PO₄, it is possible to appropriately select the added concentration by which a desirable light-emitting intensity can be obtained, without being affected by the light-emitting intensity.

In the fluorescent substance of the present invention, high light-emitting intensity and high light-emitting characteristic can be provided, by adding H₃PO₄ to incorporate P thereinto.

Moreover, when producing the fluorescent substances of the present invention, in the case of using Ce as an activator, and of adding CeO₂, as mentioned in the above, it is possible to appropriately select the added concentration of Ce by which a desirable light-emitting wavelength can be obtained, by adjusting the adding amount of Ce within the range such that the light-emitting intensity will not decrease.

The atmosphere in which the fluorescent substance of the present invention is calcined under the above condition may be an atmosphere of an inert gas such as H₂, Ar, etc., or of N₂, in particular, preferably an inert gas such as Ar, etc. The light-emitting intensity can be increased further, by calcining the fluorescent substance in an atmosphere of an inert gas such as Ar, etc. (see FIG. 1).

### Lamp

The lamp in a preferred embodiment of the present invention is equipped with an LED as a light source, and approximately constituted from the fluorescent substance of the present invention mentioned in the above, which absorbs the light emitted from the LED by the fluorescent substance and converts the wavelength thereof.

The lamp of the present invention is equipped with an LED as a light source, and a primary light-emitting wavelength from the LED is converted into a secondary light-emitting wavelength using the fluorescent substance of the present invention, thereby making the outgoing light into a wavelength having arbitrary color tone, and significantly increasing the light-emitting intensity.

The LED to be used in the lamp of the present invention as a light source is not particularly limited, as long as it can emit light with wavelength ranging from 250 nm to 600 nm, for example, ZnSe and nitride compound of element of group III semiconductor etc. can be used.

The nitride compound of an element of group III semiconductor is one which is represented by the formula: In_{α}Al_{β}Ga_{1-α-β}N (in the formula, 0≦α, 0≦β, α+β≦1). Among them, a gallium nitride type compound semiconductor is preferably used in view of efficiency. Such a gallium nitride type compound semiconductor is formed on a substrate as a light-emitting device by MOCVD method or HVPE method.

As the structure of the gallium nitride type compound semiconductor, those of a homostructure, a heterostructure, or a double heterostructure having a MIS junction, PIN junction, and pn junction are exemplary. Moreover, the light-emitting wavelength can be variously selected by the material of the semiconductor layer and the degree of intercrystallization. Moreover, it may be a single quantum well structure in which the semiconductor active layer is formed to be a thin film in which the quantum effect will be generated, or a multiplex quantum well structure.

In the case of disposing the fluorescent substance of the present invention onto an LED to form a lamp, at least one kind of fluorescent substance may be laminated and arranged as a single layer or plural layers, alternatively two or more kinds of fluorescent substances may be mixed and arranged in a single layer.

As a method of forming a fluorescent substance onto an LED, one in which a fluorescent substance is mixed with a coating member covering the surface of an LED, one in which a fluorescent substance is mixed with a mold member of an LED, or one in which a fluorescent substance is mixed with a coating body which covers a mold member, and further one in which a transparent plate into which a fluorescent substance is mixed is placed in the forward of the flooding side of the LED lamp are exemplary.

Moreover, as a method of forming a fluorescent substance, at least one kind of fluorescent substance may be added to the mold member on the LED. In addition, a fluorescent substance layer consisting of one or more kinds of fluorescent substance may be disposed outside the light-emitting device.

As a method to form a fluorescent substance outside an LED, one to apply a fluorescent substance lamellarly to the outer surface of the molding member of an LED, one to prepare a molded product (for example, a cap-shaped) in which a fluorescent substance is dispersed into a rubber, a resin, an elastomer, a low-melting point glass, etc., and to coat a light-emitting device with the resultant molded product, and one to shape the molded product into a plate and dispose this plate in front of an LED are exemplary.

In the case of mixing a fluorescent substance into a resin, the compounding ratio of the fluorescent substance to the resin, for example, may range from 0.001% to 50% by mass, but this is not exclusive. The optimum compounding ratio varies depending on efficiency, particle size, and specific gravity of a fluorescent substance, and viscosity of the resin, etc., and hence the optimum compounding ratio is in general determined corresponding thereto.

As explained above, in accordance with the fluorescent substance of the present invention and the lamp using the same, the secondary light-emitting wavelength of a fluorescent substance can be made to be a wavelength with an arbitrary color tone by the constitution and the effect in the above, and the light-emitting intensity can be increased. Thereby, it is possible to obtain light having high output and excellent light-emitting characteristics with an arbitrary color tone, by using one or more kind of fluorescent substances respectively, even if the primary light-emitting wavelength from the LED is the same wavelength.

Accordingly, a lamp having high brightness, long life, small size, and excellent general-purpose properties can be provided at a low cost.

It should be noted that since the fluorescent substance and a lamp using the same can efficiently excite particularly in blue region near 460 nm, the above excellent effect will become still more significant, in the case in which the fluorescent substance is used in an LED lamp which uses blue LED as a light source and which emits white light as a result that a fluorescent substance emits yellow light by blue LED excitation.

In addition, since the lamp of the present invention excels in versatility, the lamp can be used for wide use, such as a display, a liquid crystal display backlight, white LED, LED for use in illumination, etc.

### EXAMPLES

A concrete explanation will be given below, about the fluorescent substance of the present invention and a lamp using the same, showing Examples, however, the fluorescent substance of the present invention and a lamp using the same are not limited to the content of the following Examples.

### Example 1

FIGS. 1 and 2 are graphs which show the relative intensity (light-emitting intensity) of the maximum light-emitting peak height, and the wavelength (light-emitting wavelength) of the maximum light-emitting peak height of the fluorescent substance which was synthesized by compounding each of Y₂O₃, Al₂O₃ and CeO₂ so as to be Y_{2.91}Ce_{0.09}Al₅O₁₂, and adding H₃PO₄ as an element of group V to this, while varying the additive amount and calcining atmosphere.

As an atmosphere for calcining of the data shown in FIGS. 1 and 2, approximately 100% gas was used respectively in each of “Ar” and “N₂”, a mixed gas consisting of 4% of hydrogen and 96% of nitrogen was used in “H₂”, and an atmospheric air was used in “Atmosphere” for calcining.

As a fluorescent substance for comparison, TYPE: KX692B made by KASEI OPTO Co., Ltd. was used. This fluorescent substance is one which has the largest light-emitting intensity in all of commercially available fluorescent substances, having a light-emitting intensity ranging from 120 to 130% to that of TYPE: P46-Y3 made by KASEI OPTO Co., Ltd., which is used as a generally available fluorescent substance for reference, and in this example, the light-emitting intensity value was expressed as a relative light-emitting intensity based on the case in which the light-emitting intensity of this fluorescent substance (TYPE: KX692B) is standardized as 100%.

The correlation between the added amount of H₃PO₄ and the light-emitting intensity is shown in the graph in FIG. 1.

From this correlation, it can be seen that if the added amount of H₃PO₄ increases, then the light-emitting intensity becomes larger to obtain a light-emitting intensity of not less than 120% to that of the above fluorescent substance for reference. In addition, it can be seen that the effect appears significantly in the case of calcining in an inert gas atmosphere (Ar, N₂).

As shown in the graph of FIG. 1, in this example, the amount of H₃PO₄ to be added to the fluorescent substance ranges from 1 to 5% expressed in terms of mole %. From the result shown in FIG. 1, it is clear that the light-emitting intensity increases by adding H₃PO₄ as P to the fluorescent substance of the present invention, and that the light-emitting intensity increases still further by using an inert gas, i.e. an Ar atmosphere for calcining the fluorescent substance.

The correlation between the added amount of H₃PO₄ and the light-emitting wavelength is shown in the graph in FIG. 1.

From this correlation, it can be seen that the light-emitting wavelength of the fluorescent substance of the present invention changes little regardless of the adding amount of H₃PO₄ and that it is a very useful fluorescent substance.

As shown in the graph of FIG. 2, the light-emitting wavelength of the fluorescent substance in this example is not significantly affected by the added amount of H₃PO₄, in the case in which the added amount of H₃PO₄ ranges from 1 to 5% expressed in terms of mole %. For this reason, the added amount of H₃PO₄ can be determined regardless of the desirable light-emitting wavelength.

Accordingly, it is clear that in the fluorescent substance of the present invention, in the case of requiring a high light-emitting intensity, the light-emitting intensity of the fluorescent substance can be increased, without significantly affecting the light-emitting wavelength, by increasing the added amount of H₃PO₄ within the above range.

### Example 2

FIGS. 3 and 4 are graphs which show the relative intensity (light-emitting intensity) of the maximum light-emitting peak height, and the wavelength (light-emitting wavelength) of the maximum light-emitting peak height of the fluorescent substance which was synthesized by compounding each of Y₂O₃, Al₂O₃ and CeO₂ so as to be Y_{(3-X)}Ce_{X}Al₅O₁₂, and adding a predetermined amount of 3 mole % of H₃PO₄ as an element of group V to this, while varying the CeO₂ concentration x (mole %) and calcining atmosphere.

As an atmosphere for calcining of the data shown in FIGS. 3 and 4, approximately 100% gas was used in “N₂”, and a mixed gas consisting of 4% of hydrogen and 96% of nitrogen was used in “H₂”.

As a fluorescent substance for comparison, TYPE: KX692B made by KASEI OPTO Co., Ltd. was used, the same as in Example 1.

The correlation between the CeO₂ (Ce) concentration in the state in which H₃PO₄ was added to the fluorescent substance, and the light-emitting intensity is shown in the graph in FIG. 3.

From this correlation, it can be seen that the light-emitting intensity becomes larger corresponding to the Ce concentration, in the state in which H₃PO₄ was added to the fluorescent substance, and that the light-emitting intensity of not less than 120% to the above fluorescent substance for comparison is obtainable in N₂ atmosphere.

As shown in the graph in FIG. 3, in the fluorescent substance of the present invention, the amount of CeO₂ to be added to the fluorescent substance as an activator is set to be a Ce concentration ranging from 0.5 to 5% expressed in terms of mole %. It is clear that the light-emitting intensity of the fluorescent substance of the present invention has increased from the result shown in FIG. 3. In addition, it is clear that high light-emitting intensity can be obtained, in the case in which the light-emitting intensity in the Ce concentration within the above range is not less than 100% and the Ce concentration is in the above range, in both atmospheres of N₂ and H₂.

The correlation between the CeO₂ (Ce) concentration in the state in which H₃PO₄ was added to the fluorescent substance, and the light-emitting wavelength is shown in the graph in FIG. 4.

From this correlation, it can be seen that the light-emitting wavelength significantly varies corresponding to the Ce concentration in the state in which H₃PO₄ was added to the fluorescent substance, and that this variation is larger than the substitution effect of Gd which has been generally known. From this correlation, it is clear that a fluorescent substance with well-balanced light-emitting intensity and light-emitting wavelength can be produced by selecting the Ce concentration corresponding to use, and that it is a very useful fluorescent substance.

As shown in the graph in FIG. 4, in this example, the light-emitting wavelength varies approximately corresponding to the Ce concentration, in the case in which the Ce concentration in the fluorescent substance ranges from 0.5 to 5% expressed in terms of mole %. From the result shown in FIG. 4, it is clear that the fluorescent substance of the present invention can provide a desirable light-emitting wavelength by setting the added amount of CeO₂, in particular, the Ce concentration and the light-emitting wavelength will be in approximately a linear relationship, in the case of calcining the fluorescent substance in N₂ atmosphere.

In addition, as shown in the graph in FIG. 3 in the above, it is clear that a high light-emitting intensity can be obtained if the added amount of CeO₂ is in an amount such that it is within the range of the Ce concentration, because the light-emitting intensity is not less than 100%, in the case in which the Ce concentration is within the above range.

From these results, it is clear that the fluorescent substance of the present invention containing an activator such as Ce etc. can provide an easily desirable light-emitting wavelength as well as high light-emitting intensity.

### Example 3

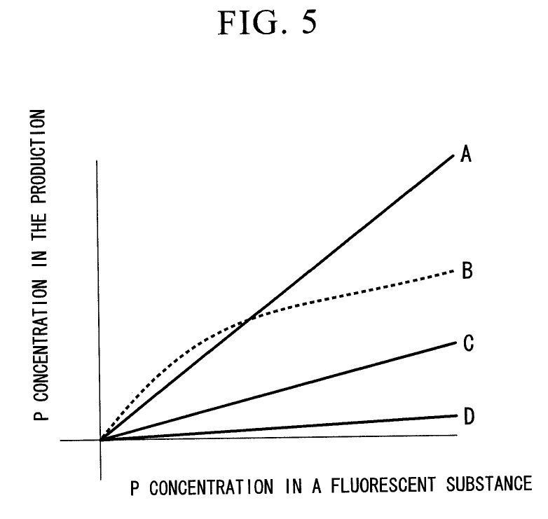

FIG. 5 is a graph which shows the correlation between the concentration of P which was added during synthesizing the fluorescent substance raw material and the concentration of P contained in the fluorescent substance after the fluorescent substance was synthesized, in the case of synthesizing a fluorescent substance by compounding each of Y₂O₃, Al₂O₃ and CeO₂ so as to be Y_{2.91}Ce_{0.09}Al₅O₁₂, and adding various P (phosphorus) compounds as an element of group V thereinto, while varying the calcining atmosphere.

In FIG. 5, each of A, B, C, and D is an example which was performed by changing the kind of P compound and the calcining atmosphere.

From the result shown in FIG. 5, it can be seen that each concentration of P which was added during synthesizing the fluorescent substance raw material and the concentration of P contained in the fluorescent substance after the fluorescent substance was synthesized varies depending on conditions such as the kind of compound of P source, synthesizing temperature, calcining atmosphere, etc., although there is a correlation to some extent therebetween.

Therefore, it can be seen that it is necessary to select appropriately and determine the proper P concentration, depending on these conditions and desirable characteristics of the fluorescent substance.

### INDUSTRIAL APPLICABILITY

The fluorescent substance of the present invention and the lamp using the same can be used in various broad uses such as a display, a light source of a backlight, a signal and various indicators etc., and the industrial utility value thereof is extremely large.

1. A fluorescent substance comprising a fluorescent substance which mainly consists of a garnet structure, and an element of group V added thereto.

2. The fluorescent substance as set forth in claim 1, wherein the fluorescent substance comprises a fluorescent substance having a garnet structure in which yttrium.aluminum.garnet (Y₃Al₅O₁₂) is contained as a base component, and further an activator.

3. The fluorescent substance as set forth in claim 1, wherein the content of the element of group V is not more than 50 mol %.

4. The fluorescent substance as set forth in claim 1, wherein the content of the element of group V is not more than 25 mol %.

5. The fluorescent substance as set forth in claim 1, wherein the element of group V is P, and is added in a state of a phosphorus compound.

6. A process for producing a fluorescent substance comprising mixing Y compound, Al compound, Ce compound, and a compound of an element of group V and calcining the resultant mixture to form a fluorescent substance which mainly consists of a garnet structure.

7. The process for producing a fluorescent substance as set forth in claim 6, comprising blending Y oxide, Al oxide, and Ce oxide so as to be a predetermined composition ratio, and further adding a phosphorus compound, and then calcining the resultant mixture.

8. The process for producing a fluorescent substance as set forth in claim 7, wherein the Y oxide is Y₂O₃, the Al oxide is Al₂O₃, the Ce oxide is CeO₂, and the phosphorus compound is H₃PO₄.

9. The process for producing a fluorescent substance as set forth in claim 6, wherein the calcining is performed in an inert gas.

10. A fluorescent substance obtained by the process as set forth in claim 6.

11. A lamp comprising an LED as a light source, and a fluorescent substance as set forth in claim 1 to absorb light emitted from the LED with the fluorescent substance and perform wavelength conversion.

12. A lamp comprising an LED as a light source, and a fluorescent substance as set forth in claim 1 to absorb light emitted from the LED with the fluorescent substance and emit white light.
